(19) United States
(12) Patent Application Publication
(10) Pub. No.: US 2006/0220528 A1
(43) Pub. Date: Oct. 5, 2006

(54) Light-emitting devices

(76) Inventors: Kai Engelhardt, Buckenhof (DE); Susanne Rechsteiner, Zurich (CH); Michael Kiy, Winterthur (CH)

Correspondence Address: FISH & RICHARDSON, PC, P.O. BOX 1022, MINNEAPOLIS, MN, 55440-1022, US

(21) Appl. No.: 10/543,964

(22) PCT Filed: Jan. 30, 2004
(86) PCT No.: PCT/GB04/00315

§ 371 Date: Apr. 11, 2006

(30) Foreign Application Priority Data
Jan. 30, 2003 (GB) 0302202.7

(51) Int. Cl. H01J 1/62

(52) U.S. Cl. 313/498

(57) ABSTRACT

A thin film light emitting device comprises a substrate (21), a first substantially flat electrode (22) deposited continuosly over a substantial portion of a surface of the substrate (21), a second electrode (25), a substantially flat electroluminescent layer (24) sandwiched between the first (22) and second (25) electrodes, and an insulating layer (23) sandwiched between the second electrode (25) and the electroluminescent layer (24). The insulating layer (23) is patterned to provide contact areas between the second electrode (25) and the electroluminescent layer (24). The contact areas lie wholly within the area of the first electrode (22) and define the shape of an area over which light is emitted when a DC voltage is applied between the first (22) and second (25) electrodes. One or more further substantially flat electrically active layer(s) may be deposited between the first electrode (22) and the insulating layer (23).

The invention relates to light-emitting devices. In this context light is to be interpreted to include not only visible radiation but also other electromagnetic radiation outside the visible wavelengths including infrared, ultraviolet and x-radiation.

The invention further relates to methods of fabricating such devices and the patterning of light-emitting areas of thin film light-emitting devices using printing methods. Thin film light-emitting devices have been described in various publications. A typical thin film light-emitting device is based on at least one electroluminescent material sandwiched between two electrical contact layers (electrodes). Additionally, other electrically active layers can be sandwiched between the electroluminescent material and the contact layers. At least one of these electrodes is transparent to transmit the light produced by the electroluminescent layers. The devices are usually based on a substrate with one electrode layer and several active layers deposited onto the electrode layer. A second electrode on top defines the sandwich-structure.

Thin film organic light-emitting devices based on small organic molecules known from the prior art usually comprise aluminescence material and, optionally, a hole-transport and/or an electron-transport material. Some materials combine both properties. VanSlyke et al. describe in U.S. Pat. No. 4,539,507 a bi-layer organic light-emitting device with improved device performance.

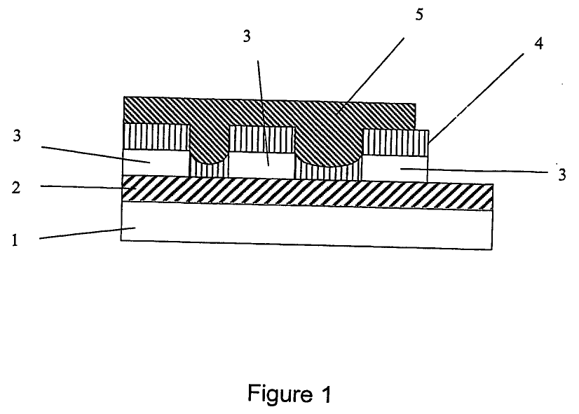

Bradley et al. teach in WO-90/13148 that, instead of evaporated small molecules, also polymers can be used as active materials. Solution-compatible thin-film deposition processes such as spin coating, ink jet printing, or doctor blade technique can deposit the polymers. FIG. 1 of WO 90/13148 gives a few examples of typical materials employed from the prior art in organic optoelectronic devices.

In the paper □Solid-State Light-Emitting Devices Based on the Tris-Chelated Ruthenium(II) Complex 4.-High-Efficiency Light-Emitting Devices Based on Derivatives of the Tris(2,2′-bipyridyl) Ruthenium(II) Complex”, Journal of the American Chemical Society, 124, 4918, 2002, Rudmann et al. describe a highly efficient light-emitting device based on electrochemical cells. An example of a light emitting electrochemical cell is a conjugated polymer blended with a solid electrolyte that provides mobile ions.

For applications, such as custom patterned light emitting devices for producing fixed logos or texts, usually a division of the emitted light areas in electrically active and non-active areas is required. This can be achieved by patterning of the electrode on the substrate and/or the electrode on the active material as is described with reference to FIG. 1B in U.S. Pat. No. 5,902,688. The active material might be also patterned, but the overlap of both contacts with the sandwiched active materials defines the overall light-emitting region.

The patterning of the top electrode on the active material cannot usually be done by etching or other solution based methods because the layers underneath the top electrode are usually sensitive to solutions. As a result this electrode is usually fabricated by vacuum deposition with shadow masks. With the shadow mask method, however, only connected patterns can be used and the flexibility is therefore limited.

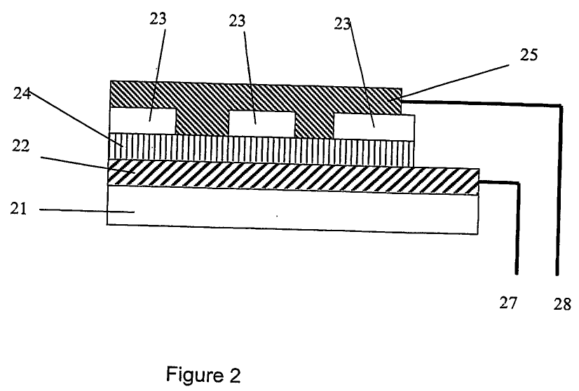

If the electrode on the substrate is patterned by etching or the insertion of an thin isolation layer, such as photo resist or a printed layer, such as is described with reference to FIG. 2 of U.S. Pat. No. 5,902,688 the following thin film deposition process, such as spin coating or vacuum deposition, might be influenced due to raised portions on the substrate and can lead to short circuits or inhomogeneous depositions.

An alternative method is to produce a patterned electroluminescent and/or electrically active layer.

Several groups have published fabrications of organic/polymer light emitting or photovoltaic devices by printing methods. They describe:

1. the printing of charge carrier injection enhancing layers onto the substrate electrode
Mori et al., Jpn. J. Appl. Phys., year 2000, Vol. 39, pp L942-L944, □Organic Light-Emitting Devices Patterned by Screen-Printing?
Jabbour et al., Proceedings of SPIE, year 2001, Vol. 4466, page 72, □Screen-Printing for the Fabrication of Organic Light-Emitting Devices”
Dino et al., Adv. Mater., year 2000, Vol. 12, Nr. 17, pp 1249-1252, □Application of Screen Printing in the Fabrication of Organic Light-Emitting Devices”

2. The printing of the charge carrier injection enhancing layers onto the substrate electrode followed by the printing of the electroluminescent layer.
J. Birnstock et al., Proceedings of SPIE, year 2002, Vol. 4464, pp 68-74, □Screen-Printed Passive Matrix Displays and Multicolor Devices”
Duineveld et al., Proceedings of SPIE, year 2002, Vol. 4464, pp 59-67, □Ink-Jet Printing of Polymer Light-Emitting Devices”

3. printing of dopants for the electroluminescent materials
Chang et al., Adv. Mater., year 1999, Vol. 11, Nr. 9, pp 734-737, □Multicolor Organic Light-Emitting Diodes Processed by Hybrid Inkjet-Printing”
Jones et al., PCT application WO 0012226

The invention provides a thin film light emitting device comprising a substrate, a first substantially flat electrode deposited continuously over a substantial portion of a surface of the substrate, a second electrode, a substantially flat electroluminescent layer sandwiched between the first and second electrodes and an insulating layer sandwiched between the second electrode and the electroluminescent layer, wherein the insulating layer is patterned to provide contact areas between the second electrode and the electroluminescent layer, the contact areas lying wholly within the area of the first electrode, to define the shape of an area over which light is emitted when a DC voltage is applied between the first and second electrodes.

The invention further provides a method of fabricating a thin film light-emitting device comprising the steps of:
depositing a first substantially flat electrode over a substantial portion of a substrate;
depositing a substantially flat electroluminescent layer on the first electrode;
depositing a patterned insulating layer on the electroluminescent layer, the insulating layer having one or more areas where it does not cover the electroluminescent layer; and
depositing a second electrode on the.insulating layer such that the second electrode is in contact with the electroluminescent layer through the one or more areas to define areas where light is emitted.

Further optional, alternative and/or advantageous features are set forth in the dependent claims.

In the device and fabrication method according to the invention the substrate and the electrodes do not have to be patterned. The electrode on the substrate and the active layer(s) can remain flat without raised portions or recesses. A printed insulation layer, such as epoxy, just on top of the active layer(s) defines the pattern and prevents the current flow in the non-active regions of the device.

The above and other features of the invention will be apparent from the following description, by way of example, of an embodiment of the invention with reference to the accompanying drawings, in which:

FIG. 1 shows a cross-sectional view of a prior art light-emitting device.

FIG. 2 shows a cross-sectional view of a first embodiment of a light emitting device according to the invention, and

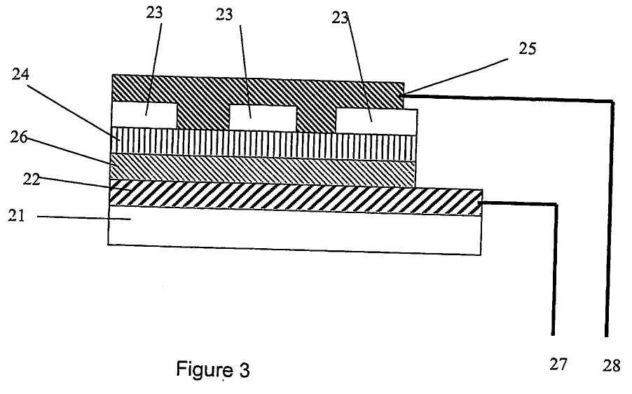

FIG. 3 is a cross-sectional view of a second embodiment of a light-emitting device according to the invention.

The printing of charge carrier injection enhancing layers onto the substrate electrode has already been proposed for producing a pattern, but is only sufficient for very high contrasts of the injection from the substrate electrode compared to the injection through the printed layer. For large devices with small light-emitting area (e.g. line art pictures) the current contribution from the non light-emitting area may play a big role and reduce the overall efficiency.

The active material might be also patterned, but the overlap of both contacts with the sandwiched active materials defines the overall light-emitting region.

H. Antoniadis et al. teaches in U.S. Pat. No. 5,902,688 that a thin isolating photo resist patterned onto the substrate electrode layer can be used to define the light emitting area in such polymer/organic light-emitting devices. This method works well for vacuum deposited organic materials, such as thin films of small molecules. In polymer devices one or more additional layers has to be deposited onto the underlying insulator from solutions. Usually spin coating is used for the deposition of the active materials. A patterned insulating layer below.the active layer hinders the production of a homogenous deposition of the active layers and usually leads to inhomogenous light emission of the complete device. Additionally, the aggressive solvents used for the polymer layers might remove the insulator or at least cause some of the insulating material to mix with the active layers and lead to impurities in the active layer. The same problems arise with printed isolating layers on the substrate electrode.

FIG. 1 is a cross-sectional view of the patterning of a light-emitting device according to the prior art, as described by H. Antoniadis et al. in U.S. Pat. No. 5,902,688, applied to a polymer light-emitting device.

The device comprises a substrate 1, an electrode 2, a patterned isolating layer 3, a spin-coated polymer layer 4 with thickness inhomogenities, and the second electrode layer 5.

As shown in FIG. 2 the device comprises a substrate 21, such as glass or a foil. An electrode layer 22 is formed on the substrate 21. The electrode layer 22 may be formed from, for example a metal, a metal alloy, a conductive polymer, or a transparent conductive layer (such as ITO). The electrode 22 is substantially flat, continuous, and covers a substantial portion of the substrate. In particular it covers the whole area over which light is to be emitted in a continuous flat layer, but may extend outside that layer to provide a convenient contact area for the application of an operating potential. The electrode 22 is covered by an electroluminescent layer 24 (such as a layer of the Ru(bpy)₃ complex). Neither of the layers 22 or 24 have to be patterned, thus the two layers are flat and can be deposited by any thin film deposition technology. A patterned layer 23 of electrically insulating material overlies the electroluminescent layer 24. The patterned layer 23 is non continuous so that one or more areas, either distinct or intercommunicating, of the electroluminescent layer 24 are left exposed so that light may be emitted over those areas. As shown in FIG. 2 a second electrode 25 is formed over the insulating layer 23 and extends through the insulating layer to contact the electroluminescent layer 24 over the areas in which liqht is to be emitted. The second electrode 25 may be formed, for example, from a metal such as silver, a metal alloy such as magnesium:silver alloy, a metal multi-layer structure such as calcium followed by an aluminium layer, a conductive polymer, or a transparent conductive layer such as ITO.

The pattern on the layer 23 determines the shape of an illuminated area when an electrical potential is applied between the electrode layers 22 and 25 via terminals 27 and 28. By this means illuminated alphanumeric characters, icons, logos, etc may be produced.

FIG. 3 is a cross-sectional view of a second embodiment of a light-emitting device according to the invention having both electroluminescent and electrically active layers. Elements corresponding to those in the first embodiment of the invention shown in FIG. 2 have been given the same reference signs.

As shown in FIG. 3 the device comprises a substrate 21, such as glass or a foil. An electrode layer 22 is formed on the substrate 21. The electrode layer 22 may be formed from, for example a metal, a metal alloy, a conductive polymer, or a transparent conductive layer (such as ITO). The electrode 22 is covered by an electrically active layer 26 (such as a layer poly-(ethylene dioxythiophene) doped with polystyrene sulphonic acid (PEDOT:PSS)) followed by the coating of the electroluminescent layer 24 (such as poly(9,9-dioctylfluorene) (F8)). None of the layers 22, 24 or 26 are patterned, thus the two layers can be deposited by any thin film deposition technology with very high homogeneity. A patterned layer 23 of electrically insulating material overlies the electroluminescent layer 24. The patterned layer 23 is non continuous so that one or more areas, either distinct or intercommunicating, of the electroluminescent layer are left exposed so that light may be emitted over those areas. As shown in FIG. 3 a second electrode 25 is formed over the insulating layer 23 and extends through the insulating layer to contact the electroluminescent layer 24 over the areas from which light is to be emitted. The device has terminals 27 and 28 for connection to a DC voltage source such as a battery.

In one example of a method of fabricating such a device a substrate (such as glass or a plastic foil) with a transparent and conductive layer (such as a thin film of indium tin oxide—ITO) is produced without patterning. The conductive layer forms the first electrode. A number of polymer layers (such as PEDOT:PSS and LPPP) or organic molecule layers (such as NPB and Alq₃) are deposited onto the substrate over the conductive layer to form an electroluminescent layer by any thin film deposition technology (such as spin-coating, doctor blade deposition, screen printing or vacuum decomposition). Then an insulating layer with the shape of the inverse of the light emitting area is printed by a printing technology (such as screen printing, laser-toner printing, ink-jet printing, or wax printing). The overall printed area is preferably smaller than the substrate to allow an easy contacting of the electrodes. Afterwards the second electrode (such as a thin barium, magnesium, calcium or other low work function metal layer followed by an capping layer such as aluminium, silver) is deposited onto the insulating layer to contact the electroluminescent layer through.the pattern of holes in the insulating layer.

For the screen-printing of the insulating layer an epoxy (such as Epoxy Technology EPO-TEK 353ND-T) in combination with a screen printer (such as a manual screen printer from Dickfilm Systems AG Switzerland) with stainless steel strainer can be used. A suitable mesh density is in the order of 400 mesh/inch, with a thread thickness in the order of 25 micrometers.

The resulting thickness of the printed layer has to have an adequate thickness to insulate the active material from the electrode even at high electric fields, such as 1 MV/cm and thin enough to allow the electrode layer on top of the patterned area to extend through the apertures in the insulating layer to contact the electroluminescent layer. In the present embodiment with the above-mentioned screen-printing technology film thickness between 20 and 30 microns may be achieved.

1. A thin film light emitting device comprising a substrate, a first substantially flat electrode deposited continuously over a substantial portion of a surface of the substrate, a second electrode, a substantially flat electroluminescent layer sandwiched between the first and second electrodes, and an insulating layer sandwiched between the second electrode and the electroluminescent layer, wherein the insulating layer is patterned to provide contact areas between the second electrode and the electroluminescent layer, the contact areas lying wholly within the area of the first electrode, to define the shape of an area over which light is emitted when a DC voltage is applied between the first and second electrodes.

2. A device as claimed in claim 1 in which the substrate and first electrode are transparent.

3. A device as claimed in claim 1 in which one or more further substantially flat electrically active layer(s) is/are deposited between the first electrode and the insulating layer.

4. A method of fabricating a thin film light-emitting device comprising the steps of:
depositing a first substantially flat electrode over a substantial portion of a substrate;
depositing a substantially flat electroluminescent layer on the first electrode;
depositing a patterned insulating layer on the electroluminescent layer, the insulating layer having one or more areas where it does not cover the electroluminescent layer; and
depositing a second electrode on the insulating layer such that the second electrode is in contact with the electroluminescent layer through the one or more areas to define areas where light is emitted.

5. A method as claimed in claim 4 comprising the step of depositing substantially flat electrically active layer on the first electrode.

6. A method as claimed in claim 4 in which the electrically and/or electroluminescent layer is deposited by spin coating.

7. A method as claimed in claim 4 in which the electrically and/or electroluminescent layer is deposited by doctor blade deposition.

8. A method as claimed in claim 4 in which the electrically and/or electroluminescent layer is deposited by screen printing.

9. A method as claimed in claim 4 in which the electrically and/or electroluminescent layer is deposited by vacuum deposition.

10. A method as claimed in claim 4 in which the overall area of the insulating layer is smaller than that of the substrate.

11. A method as claimed in claim 4 in which the insulating layer is deposited by screen printing.
